(19) United States
(12) Patent Application Publication
(10) Pub. No.: US 2019/0251933 A1
(43) Pub. Date: Aug. 15, 2019

(54) String maintenance hand tool for stringed acoustic and electric guitars and other stringed musical instruments with fingerboard wire strings.

(71) Applicant: PAUL SAENZ WONG, II, SAN DIEGO, CA (US)

(72) Inventor: PAUL SAENZ WONG, II, SAN DIEGO, CA (US)

(21) Appl. No.: 16/267,392

(22) Filed: Feb. 5, 2019

Related U.S. Application Data
(60) Provisional application No. 62/626,312, filed on Feb. 5, 2018.

(51) Int. Cl. G10D 3/10

(52) U.S. Cl. CPC G10D 3/10

(57) ABSTRACT

An implement which embodies magnetic properties and microfibers to remove accumulated organic deposits and electrostatic discharge on metal wire musical instrument strings installed upon the neck of such instruments, namely, for maintenance of common guitars and cleaning of guitar strings. A non-electric, hand tool, whose principal magnetized internal components mimic the geometry of neck and string contours of most acoustic and electric guitars, utilizing a novel, user replaceable two-part “tongue and groove” system, supported by a three-part hinged framework. The method encapsulates metal strings in 360 degrees of magnetic grip between microfiber material when the user cleans strings in place on the fingerboard. The marketplace position is directed to and determined by common household users, amateur players and professional musicians seeking a technology-enhanced alternative for metal string maintenance of musical instruments of all kinds, but particularly for premium acoustic and electric guitars in everyday use around the world.

### FIELD OF THE INVENTION

The present invention is generally to maintain and clean metal wire strings on common household stringed musical instruments. More acutely, it is for all types of metal string instruments used in the Music Industry et al., in entertainment venues, in recording studios, and practice facilities by amateur and professional working musicians, utilizing electric and acoustic instruments, the strings of which require cleaning, i.e. the removal of residue adherents before and after practice and performances.

Specifically for guitars, bass, banjo, mandolin, etc., and any musical instrument with metal strings used by performers in coffee shops, lounges, nightclubs, studios and professional touring musicians worldwide performing in varied climates, particularly hot and humid climates, where conditions promote grime, dirt, perspiration and body oils to transfer from the environment and from the player's fingers and hands onto strings.

Without persistent cleaning on a daily basis, metal strings rapidly deteriorate, and critical aesthetic tone is impeded limiting the projection of an instrument's inherent sound quality. The playability of the instrument is grossly affected, and the ultimate player experience is not attained. Moreover, strings become prone to untimely breakage requiring the often-inconvenient reinstallation of replacement strings, a time-consuming task.

### BACKGROUND OF THE INVENTION

It's estimated that 20%, or 1 in 5 people in the world today play and own at least one metal stringed musical instrument. At six strings on average per instrument, that could tally-up to as many as 9 or 10 billion strings in use at any given moment in time.

Players of metal-stringed musical instruments spend many hours with both hands and fingers manipulating the strings on the fingerboard of the instrument during practice and performance. Strings instantly collect organic deposits, become saturated quickly with body moisture and oils and adhere all manner of dirt and grime in the fine, metallic, microscopic pores, which leads to oxidation and electrochemical reactions that deteriorates the wire. If not regularly wiped thereafter, strings become increasingly unresponsive, flat, or dead in tone, as corrosion accelerates, and replacement is warranted to return brightness and tonal musicality to very often high-priced instruments that depend on pristine metal strings to project the full spectrum of inherent sound qualities.

When the player or artist perceives a deficiency in sound quality in the stringed musical instrument, the ultimate aural interaction of instrument and performer is impeded, and the appeal of the performance may suffer in the ears of both performer and listener.

Despite the foregoing, the need for metal string maintenance and cleaning has never really captured, certainly never fired the imagination of string instrument players and may be considered by many an unimportant afterthought. The simple truth in theory is: players are loathe to do any kind of clean-up after playing, probably because of the mindless nature of the chore, immediately in contrast to the creative endeavor of actually playing the musical instrument. Even when a handy cloth or towel is at the ready, a clean-up may not happen for weeks, months, or in some cases—never.

Prior art as early as 1985, exemplified in U.S. Pat. No. 4,528,889, shows some attention to this matter in a rudimentary example of applying an article between a fretboard and strings to affect a cleaning process. No less than twenty years passed before someone else came up with a slight improvement on the same basic principle, in Design Patent D563,067 S.

Later Patent office entries, D612,557 S; U.S. Pat. No. 8,132,286 B2; and Patent Application 2017/0206865, by the same inventor, reinforces aspects of a simple apparatus that intends to clean strings but may only offer marginal efficacy due to the fact that the process relies on the user applying force to bear down and envelop strings. In contrast, the present invention uses the power of magnetism to capture metal strings in the cleaning process.

One of the goals of the present invention is to inspire and excite amateurs and professionals to consider an updated, modern, technology-enhanced metal string cleaning system in the hope of renewing interest and awareness of maintaining the tone and integrity of fine, and expensive musical instruments.

### BRIEF SUMMARY OF THE INVENTION

The present invention comprises both material embodiments and embodiments of physics, not discovered in any prior art in USPTO search engines, where the search for words—1) string clean(er/ing), 2) musical instrument string clean(er/ing), 3) metal string clean(er/ing), 4) string clean(er/ing) tool, 5) string clean(er/ing) systems; and similar exhaustive search for related pertinent terms—is conducted on the catalog of antecedent Patent registrations at USPTO.

The present invention specifically relates to METAL wire strings installed on stringed acoustic and electric musical instruments such as guitars, banjos and basses, and any other metal stringed instrument able to emit sound by the vibration of strings on a nominal fingerboard. Metal strings are key in the design and in the function of the embodied technology. Moreover, the terms “metal strings” is rarely found in the literature of the foregoing patent search documents and therefore may not be paramount to the utility of those patents. In contrast, metal wire strings are essential to the utility of the present invention.

The present invention is an interconnected framework of five (5) supporting parts. Two of the five parts described are enhanced, replaceable and central to the principle functionality and utility of the implement as a maintenance tool, as these “tongue and groove” parts comprise installed magnets and microfibers which are the crux of a modern solution for an old problem never adequately addressed by anyone. In a brief summary, for clarity, these five parts are described generically:
(1) Top and (2) Base are latched together by (3) Hinge
(3) Hinge is force-latched for permanent connection onto molded in manufacture sphere posts of (1) and (2)
(1) Top and (2) Base have connection ports for (4) Tongue and (5) Groove modules, user replaceable parts of a “tongue and groove” system on the framework of (1), (2), and (3)

The present invention uses a previously undiscovered combination of embodiments, materials and technology in a compact gadget that separates itself from other simple string cleaning processes in USPTO Class 021. The entirety of form and figure—including options for external ornamentation of the retail product—its geometric algorithm, 3D modeling, dimensions, and class of magnets of the aforementioned “tongue and groove” system, are pending in a separate Design Patent related to this application and considered inventor trade secrets.

The present invention stands apart from competitors and should be considered a precision hand tool, not a mundane household cleaning utensil. It will be positioned in the marketplace as an advanced alternative for sophisticated users who have thus far shunned earlier, simpler processes, some of which may be no more than flimsy Swiffer containers or household gadgets of questionable merit.

The Trademark name application in progress at USPTO, Application Serial No. 88093099, Goods and services: IC 008. US 023, 028, 044: String-A-Ling Guitar Kleen

### BRIEF DESCRIPTION OF THE DRAWINGS

Some embodiments of the present invention are depicted as an example of the specification and are not limited by the Figures in the accompanying drawings, in which like references may indicate a similar element. Moreover, some Modules in the Figures are composite views of assembled modules and described as such for enhanced clarity.

FIG. 1, Front Page View. Assembled unit (not at scale). User ready. Approximate real dimensions of 5.2 cm (2″ in.) across by 13 cm (5″ in.) long by 1.5 cm tall (⅝″ in.).

Suggested image for inclusion on the front page of the patent application publication and patent as an illustration of the invention.

FIG. 2, Exploded View. The five (5) separated parts embraced by a bracket to show the relationship or order of assembly of the invention.

FIG. 3, Elevation. Front view of [29], Base Platform. Arrows at [30] point to symmetrical, rectangular port openings in [29], for other components in the assembly.

FIG. 4, Elevation. Bottom view of [29], Base Platform. [31] is a Fret Protector plane enhanced with a cushion material. [33] is hollow for Desiccant Inserts within [30] port openings.

FIG. 5, Elevation. Bottom view of [29], Base Platform. Molded in manufacture are twin Force Hinge Spheres at [32HS].

FIG. 6, Elevation. Front view of [34], Replaceable Groove Module. Groove Microfibers, for cleaning and static discharge, are installed in lanes as indicated by shading.

FIG. 7 Elevation. Top view of [34], Replaceable Groove Module. Twin extensions [35] correspond with port openings [30] on [29] Base, where the part is assembled. The lane geometry and shading of [36], for six-string instrument, is indicated.

FIG. 8, Elevation. Bottom view of [34], Replaceable Groove Module. Form shown of non-descript flat plane on reverse side.

FIG. 9, Section. End view of one side of [34], Replaceable Groove Module.

FIG. 10, Section. End view of alternate side of [34], Replaceable Groove Module.

FIG. 11, Elevation. Front view. Base Platform/Groove Assembly Module [37]: i.e. Replaceable Groove Module [34] inserted into ports [30] of Base Platform [29]. [34] is loose fitting via [35] extensions on either end of [34]. Fit allows for free upward and downward movement.

FIG. 12, Elevation. Top view of [37], Base Platform/Groove Assembly Module. [36] points to embedded microfibers in the lane geometry of [34] for six-string instrument.

FIG. 13, Section. End view of [37], Base Platform/Groove Assembly Module. [37LU] is a view of the Left-side when Replaceable Groove Module [34] is Up. [37S] depicts the open Space when [34] is in the Up position. [33] is hollow for desiccant material.

FIG. 14, Section. End view of [37], Base Platform/Groove Assembly Module. [37RL] is a view of the Right-side when Replaceable Groove Module [34] rests at the Low position with no visible opening. [33] is hollow for desiccant material.

FIG. 15, Elevation. Front view of [38], Force Hinge. [39] are 10 mm openings forced at assembly into molded sphere posts [37HS] on Base Platform [29]; and [47HS] on Top Platform [45].

FIG. 16, Elevation. Bottom view of [38], Force Hinge. [39] are 10 mm openings on the opposite side of the part.

FIG. 17, Section. End view of [38], Force Hinge.

FIG. 18, Elevation. Top view of [38], Force Hinge.

FIG. 19, Elevation. Top and front view of [40], Replaceable Tongue Module. [41] points to Tongue Microfibers on the surface area of six tongues for six-string instrument.

FIG. 20, Section. End view of [40], Replaceable Tongue Module and [42] assembly points.

FIG. 21, Elevation. Bottom view of [40], Replaceable Tongue Module. Four assembly points shown at [42].

FIG. 22, Elevation. Bottom view of [40], Replaceable Tongue Module. Molded in manufacture at [43] are three (3) rectangular slots. Each measures 40 mm×6 mm×3 mm.

FIG. 23, Elevation. Bottom view of [40], Replaceable Tongue Module, with exploded view of three (3) Neodymium N52 Bar Magnets [44], each measure 40 mm×6 mm×3 mm. Custom form sized by manufacture for corresponding fit into FIG. 22 [43] slots.

FIG. 24, Elevation. Top and bottom orthographic view, for clarity, of [40], Replaceable Tongue Module.

FIG. 25, Elevation. Bottom view of [40], Replaceable Tongue Module. [44] magnets flush fit into FIG. 22 [43] slots.

FIG. 26, Elevation. Top and front view of [45], Top Platform Module.

FIG. 27, Elevation. Bottom view of [45], Top Platform Module. Female assembly ports at [46]. Force Hinge Spheres at [47HS] are indicated.

FIG. 28, Elevation. Bottom and side view of [45], Top Platform Module. Force Hinge Spheres indicated at[47HS].

FIG. 29, Elevation. Bottom and side view, Top Platform/Tongue Assembly Module [47]: i.e. [40] Replaceable Tongue Module installed into [45] Top Platform via underlying [46] ports on [45] mated with four [42] insert points on [40].

FIG. 30, Elevation. Bottom view of [47], Top Platform/Tongue Assembly Module. Tongue Microfibers at [41] are shown on the surface of six tongues for six-string instrument. Force Hinge Spheres indicated at[47HS].

FIG. 31, Elevation. Orthographic representation of the invention with an indication of movement in operation.

### DETAILED DESCRIPTION OF THE INVENTION

The terminology used herein is for the purpose of describing particular embodiments only and is not intended to be limiting of the present invention. Unless otherwise defined, all terms used herein have the same meaning as commonly understood by anyone with ordinary skill in the art to make and use some or all of the embodiments of the present invention.

Descriptions of the comprised parts in the drawings and details of the inner workings of the present invention reveals a combination of embodiments not previously discovered in the art of string cleaning. The present invention is a distinct and rare implementation of materials, algorithm, geometry and technology that set the inventor's claims apart from other simple metal string cleaning methods.

The following description endeavors to provide the inventor's Best Mode imagined of the present invention.

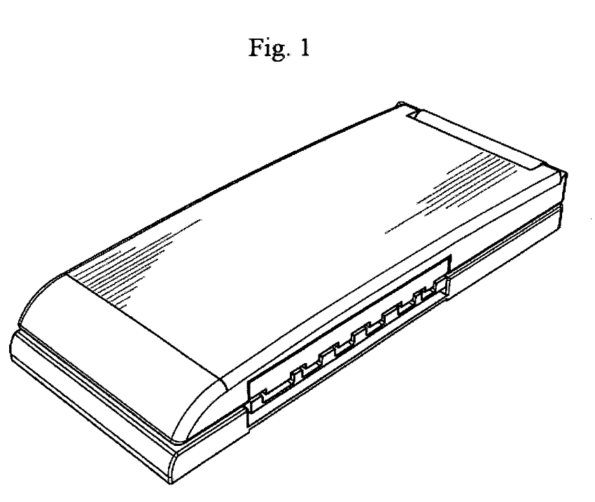

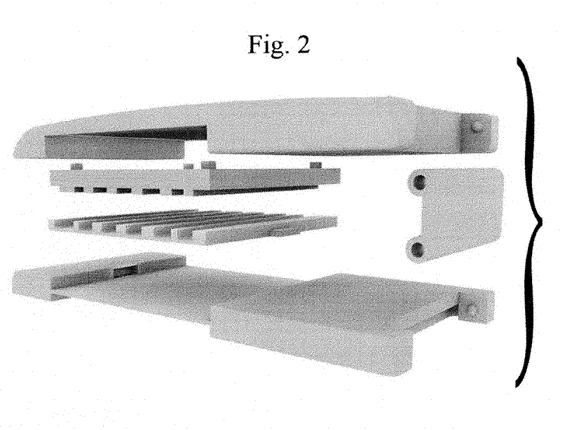

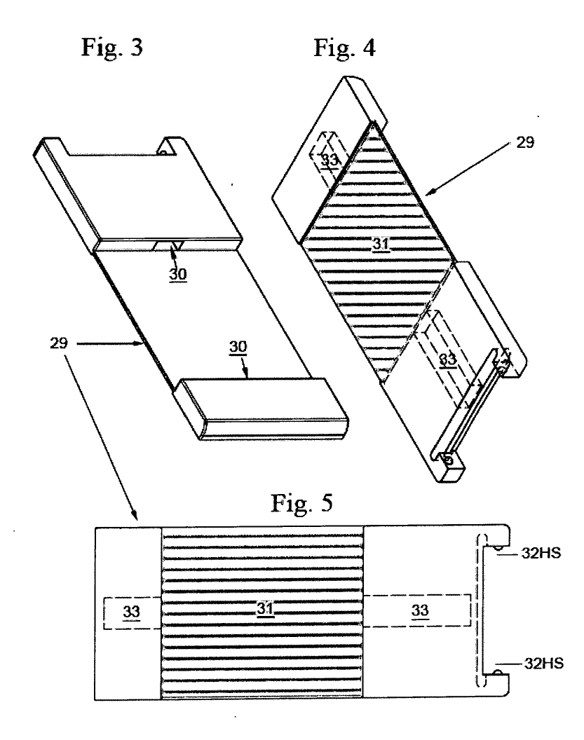

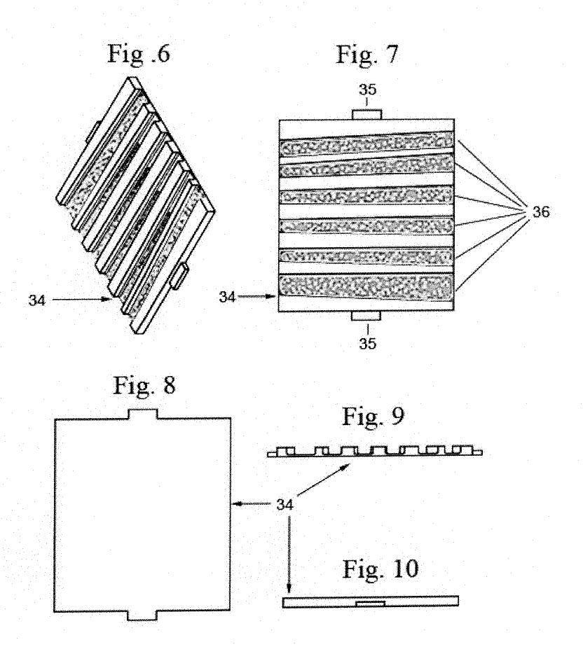

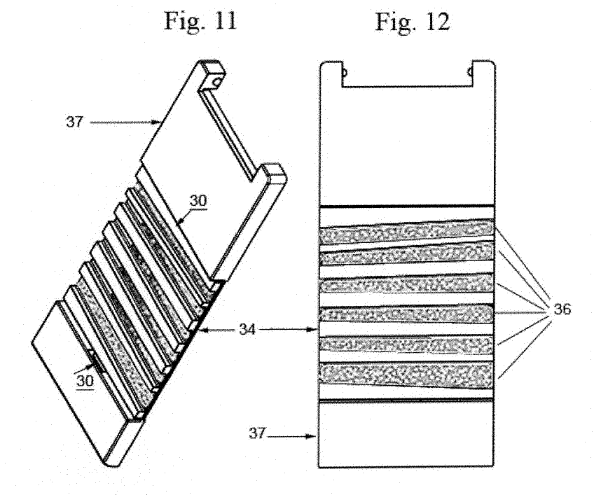

The present invention is comprised of five (5) parts, injection molded, or similar fabrication method, with supplementary materials installed later. When all of the parts are interconnected into the unified framework, it becomes a self-contained, hand-held tool, designed generally to fit on average into the palm of the hand, or between thumb and fingers of the right hand (reverse operation for left-hand). From the resting position, as depicted in FIG. 1, the user may lift the top cover and it will swivel on the hinge upward, revealing the geometry and microfibers of the replaceable parts installed within as shown in the representation of FIG. 31.

In preparation for a cleaning, for example, of a six-string guitar, the user may place the instrument down on a flat surface, with the tuning keys at the farthest point and the sound hole (acoustics) or pickups (electric) directly in front of the user. In Best Mode operation, the user will use both hands to handle the initial placement of the tool. For righthand operation, the left hand will grasp the base platform [37], while the righthand will open and swivel the top platform [47] 180 degrees on the hinge [38] until both the top platform and bottom platform are generally in parallel with each other and wide open.

With both hands adjusting the lateral movement of the tool into the space between the body of the instrument and the strings, the base platform [37] is positioned underneath the strings. The right and left hands together continue to adjust overall movement of the base platform according to the geometry of the instrument strings, with the lanes of the cleaning grooves aligned directly under the strings. The right hand may then swivel the top platform [47] to close down upon the lanes of the base platform [37] in a Tongue and Groove operation.

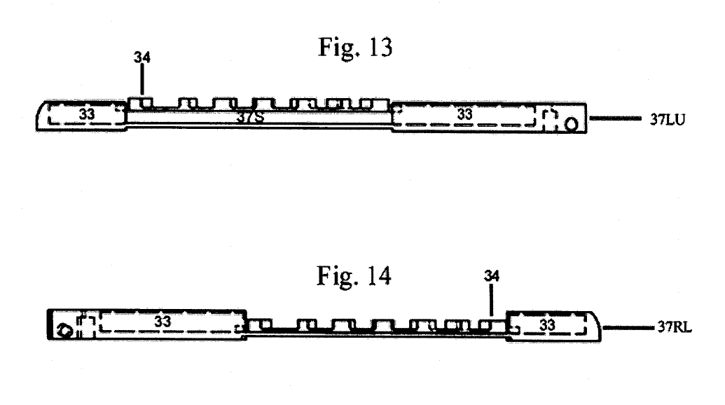

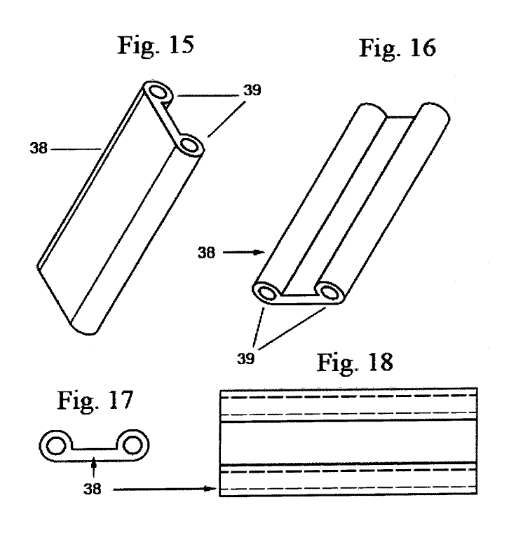

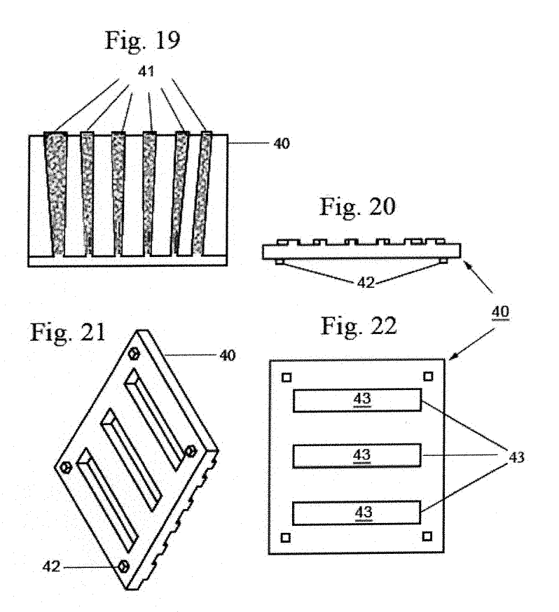

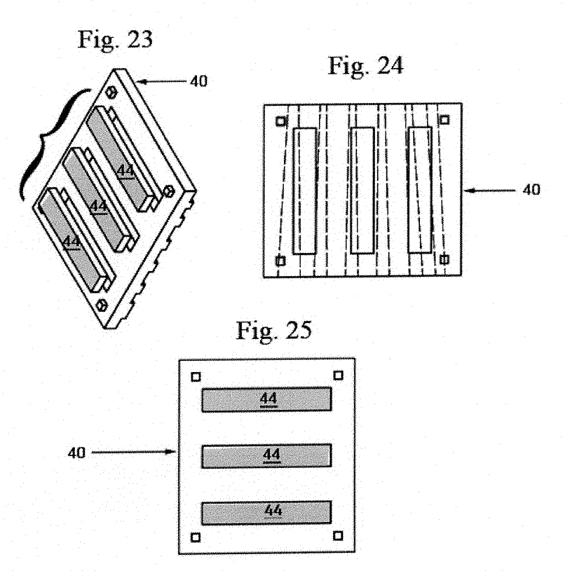

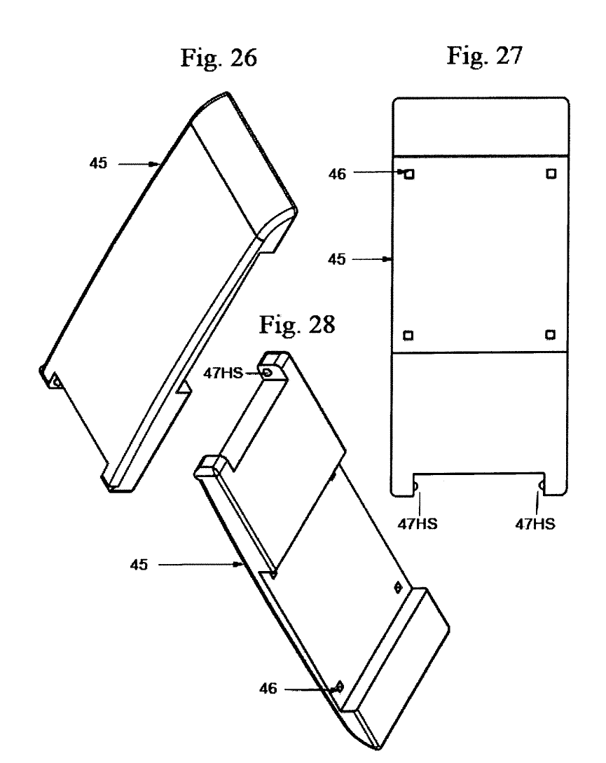

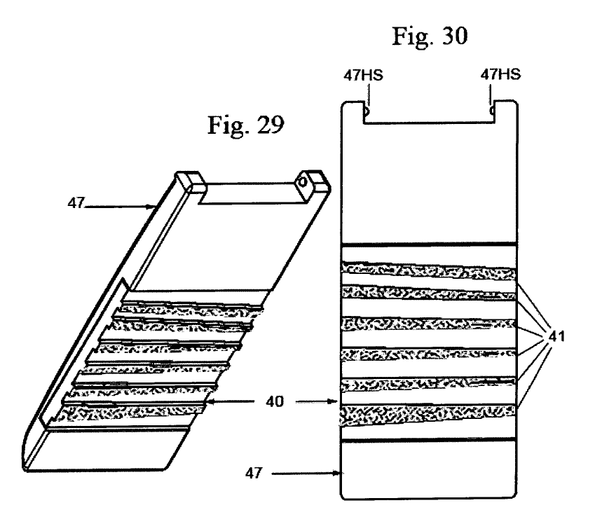

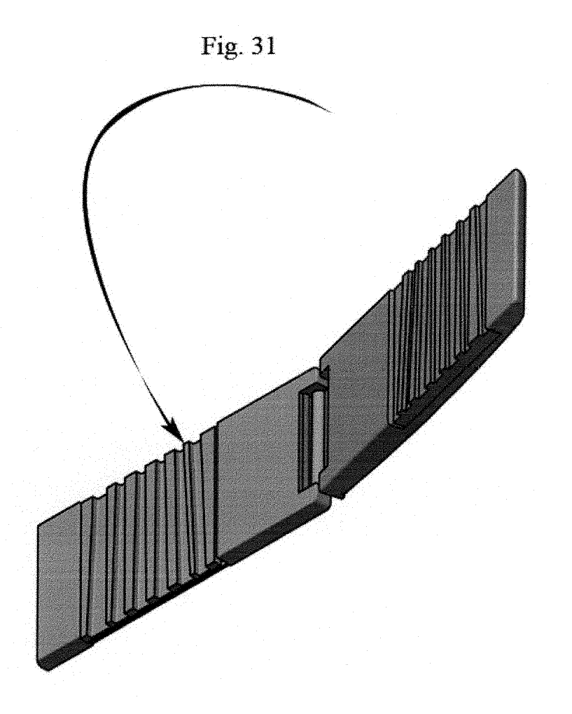

Top Platform/Tongue Assembly Module [47] comprises magnets (FIG. 23-25, [44]); and Base Platform/Groove Assembly Module [37] moves freely in the vertical position (FIG. 13, [37S]). Therefore, when the top platform [47] closes down upon the bottom platform [37], the magnetized Tongue and Groove microfiber surfaces attract and envelop the metal wire strings in 360 degrees of magnet force to affect an enhanced cleaning.

The Replaceable Groove Module [34] is manufactured with a special 3D filament material embedded with metallic particles, imparting iron-like, magnetic properties. Although [34] is not a stand-alone magnet—it cannot attract a like piece to itself—it will attract to and attach to any standard magnet placed nearby or against its surface. Therefore, the Replaceable Groove Module [34] magnetically attracts to the magnets installed in the Top Platform/Tongue Assembly Module [47] when it closes on [34].

With the metal strings in the magnetic grip of the tool in the cleaning phase of Best Mode operation, the user may then glide the tool along and up the entire neck of the instrument with either hand. The Fret Protector cushion material (FIG. 4-5, [31]) protects metal frets from scratching during the cleaning phase. The same action is then reversed and returned down the neck. The process may be completed once or twice in a routine maintenance operation that performs three functions:
1) thorough removal of organic deposits by absorption into microfibers in the top and base platforms
2) neutralization of electrochemical adherents
3) discharge of electrostatic build-up in highly charged climates and/or high-voltage performance environments

Anticipating that the post-purchase resting position of the marketplace retail product, when not in use, will be inside a musical instrument case, the present invention also includes hollow compartments (FIG. 3-5, [33]) for Desiccant Inserts, for the absorption of wood damaging moisture and condensation that may accumulate inside such closed instrument cases in any climate, but especially in hot, humid climates around the world.

Inexpensive consumer replaceable parts will be available to refresh the tool periodically:
1. Replaceable Tongue Module, [40], with pre-installed Neodymium magnets and Groove Microfibers.
2. Replaceable Groove Module, [34], with pre-installed Groove Microfibers.

What is claimed is:

1. Implementation of magnetic force and microfiber coupling in a string maintenance hand tool for stringed acoustic and electric guitars and other stringed musical instruments with fingerboard wire strings.

2. Development of 3D algorithm that mimics the geometry of neck and fingerboard contours of popular stringed musical instruments, a trade secret.

3. Previously undiscovered combination of embodiments and features in a handy, hand-held, compact gadget for cleaning metal wire guitar strings.
